(19) United States
(12) Patent Application Publication
(10) Pub. No.: US 2017/0111587 A1
(43) Pub. Date: Apr. 20, 2017

(54) NAVIGATION DEVICE WIRELESSLY COUPLED WITH AUXILIARY CAMERA UNIT

(71) Applicant: Garmin Switzerland GmbH, Schaffhausen (CH)

(72) Inventors: Caleb J. Herbst, Lenexa, KS (US); Nicholas J. Gay, Olathe, KS (US); Patrick R. Gitchell, Olathe, KS (US); Cristian N. Nicoara, Cluj-Napoca (RO)

(21) Appl. No.: 14/883,355

(22) Filed: Oct. 14, 2015

(51) Int. Cl. H04N 5/232; G01C 21/36; H04N 5/369; B60R 1/00; H04N 5/44

(52) U.S. Cl. CPC H04N 5/23293; B60R 1/00; H04N 5/44; H04N 5/3698; G01C 21/3667; G01C 21/3626; B60R 2300/8013; B60R 2300/8066

(57) ABSTRACT

Techniques are provided for implementing a camera display system with selective activation of one or more associated auxiliary camera units by a navigation device in wireless communication with the auxiliary camera units. The navigation device selectively activates auxiliary camera units when video data from the auxiliary camera unit is to be displayed on the navigation device. The navigation device transmit an activation signal that may be received by an auxiliary camera unit, which may transition to an active state and begin transmitting video data captured by the video camera to the navigation device. Selective activation of an auxiliary camera unit reduces the amount of energy consumed by the auxiliary video camera unit because it is not continuously capturing and transmitting video data to the navigation device. auxiliary camera units may be activated in response to a user input or automatically in response to triggering events.

### BACKGROUND

Because of their relatively small size and form, mobile electronic devices, such as personal navigation devices (PNDs) offer several practical advantages with respect to providing maps and map-related content to a user. For example, because of their small form and consequent portability, mobile electronic devices are capable of providing real-time navigational instructions to users in a convenient fashion, while the users are enroute to a destination.

Mobile electronic devices are often used within a vehicle for providing the driver with navigational instructions. The driver may also rely on other mobile electronic devices to present information from other data sources, such as a back-up camera connected using one or more wires to communicate electrical signals or information or a camera oriented to provide a view of passengers seated in the front seats and/or back seat. Traditionally, each data source in a vehicle environment is associated with its own display screen or an area thereof on which the data is transmitted and presented to a driver. As more video data sources become available, however, it is important to present helpful information in an intuitive manner. Furthermore, to continually generate data for display, the data sources require a large amount of power, limiting their use and deployment.

### SUMMARY

Embodiments of the present technology relate generally to a camera display system comprising a navigation device and an auxiliary camera unit. In embodiments, the navigation device may include a memory operable to store map data, video data and a video display duration, a position-determining component operable to determine a geographic position of the navigation device, a first wireless transceiver, a display having a touch screen, the display operable to display a portion of the map data corresponding to the determined geographic position of the navigation device, and a first processor operable to cause the wireless transceiver to transmit an activation signal including the video display duration and present video data received by the wireless transceiver on the display. The auxiliary camera unit may include a video camera operable to capture video data, a second wireless transceiver operable to communicate with the first wireless transceiver, and a second processor operable to transition to an active state and cause the second wireless transceiver to begin transmitting video data captured by the video camera to the navigation device for the video display duration when the second wireless transceiver is determined to receive the activation signal from the first wireless transceiver. Unlike conventional systems, each auxiliary camera unit's power consumption may be reduced because it is not continuously operating. This reduced power consumption may enable the auxiliary to utilize a power source that provides less power and utilize a replaceable and/or rechargeable battery.

This Summary is provided solely to introduce subject matter that is fully described in the Detailed Description and Drawings. Accordingly, the Summary should not be considered to describe essential features nor be used to determine a scope of the claims. Other aspects and advantages of the present technology will be apparent from the following detailed description of the embodiments and the accompanying drawing figures.

### BRIEF DESCRIPTION OF THE DRAWINGS

The detailed description is described with reference to the accompanying figures. The use of the same reference numbers in different instances in the description and the figures may indicate similar or identical items.

FIG. 1 is an illustration of an example environment in which techniques may be implemented in a mobile electronic device to selectively activate auxiliary camera units;

FIG. 2 depicts a system-level diagram of an auxiliary camera unit usable in certain implementations;

FIG. 3A depicts a mapping interface suitable for display on the device of FIG. 1;

FIG. 3B depicts an alternate mode of the mapping interface of FIG. 3A;

FIG. 4A depicts a first camera-view interface suitable for display on the device of FIG. 1;

FIG. 4B depicts a second camera-view interface suitable for display on the device of FIG. 1;

FIG. 5 depicts an exemplary deployment scenario for an implementation; and

FIG. 6 depicts a flowchart illustrating the operation of a method of selectively activating auxiliary camera units.

### DETAILED DESCRIPTION

### Overview

As additional sources of in-vehicle data are made available for providing information that may be presented to a vehicle operator, it is important to present helpful information in an intuitive manner. Moreover, the vehicle console becomes crowded with various electronic devices serving as data sources for the in-vehicle data increase. For example, a driver may have a navigation device showing map data for geographic area surrounding the vehicle, a back-up camera showing a live view of the area in the immediate vicinity (e.g., in front, behind, etc.) of the vehicle, a camera located within the vehicle showing a live view of the front and/or back seat, and a dash camera typically mounted on the vehicle windshield for recording a driver's-eye view of driving incidents. If a separate display is used to present navigation and video content to a vehicle operator, each device's display may distract the driver.

Each of these sources of information (e.g., navigation device, back-up camera, camera located within vehicle, etc.) require electrical power when capturing and presenting the navigation and video content to the driver. For example, the navigation device requires power to operate a global positioning system receiver, access a memory storing map data, and present map data with navigational instructions on a display. Similarly, back-up cameras, cameras located within the vehicle, and dash cameras require electrical power to capture and transmit the video data to a display. This energy consumption is typically not a significant concern when external power sources are used. However, for navigation devices and auxiliary camera units that do not have an external power source, managing energy consumption is important to extend the time the navigation devices and auxiliary camera units may be used. For example, the amount of electrical energy required for continuous video capture and transmission of video data from back-up cameras, baby cameras, and the like, necessitates either an external power source, such as wiring the navigation device and/or auxiliary camera unit to power sources within the vehicle (e.g., alternator, battery, etc.). This is inconvenient to a driver who desires to install and use such navigation devices and auxiliary camera units.

Accordingly, embodiments described herein include a mobile electronic device communicatively coupled with an auxiliary camera unit including a video camera that may be placed in an energy-efficient, power-saving mode when the video data is not presented on a display. In embodiments, a single camera display system with an easily accessible input selector for selective activation of a particular auxiliary camera unit is provided, thereby reducing the energy required to operate the system and the space used in the vehicle to present video content. When the user desires to view the video content from a particular auxiliary camera unit, that auxiliary camera unit can be activated for a brief period of time and then restored to the energy-efficient, power-saving mode when the user is done viewing video content from the auxiliary camera unit. In embodiments, the period of time for which the auxiliary camera unit is activated may be selectable by a user. For instance, a navigation device in communication with the auxiliary camera unit may present information on a user interface to enable a user of the camera display system to select or enter a desired video display duration.

In addition to reduced energy consumption, the user may mount the auxiliary camera unit including a video camera relative to the vehicle without electrically connecting the camera to the vehicle's power supply. Implementations thus include battery-powered cameras to allow easy installation of the auxiliary camera unit anywhere it can be mounted without consideration of access to an external power source. For example, an auxiliary camera unit may be incorporated into a license-plate frame to serve as a back-up camera or the auxiliary camera unit may be mounted on the back of a headrest (e.g., on a support pole for the headrest), without concerns for running power wires electrically coupled to a an external power source within the vehicle.

In the following discussion, an example mobile electronic device and environment is first described. Exemplary displays are then described that may be used in the illustrated environment, as well as in other environments without departing from the spirit and scope thereof. Next, an exemplary deployment of an implementation is described and finally, exemplary procedures are then described that may be employed with the example environment, as well as with other environments and devices without departing from the spirit and scope thereof.

Exemplary Mobile Device, Auxiliary Camera Unit, and Environment

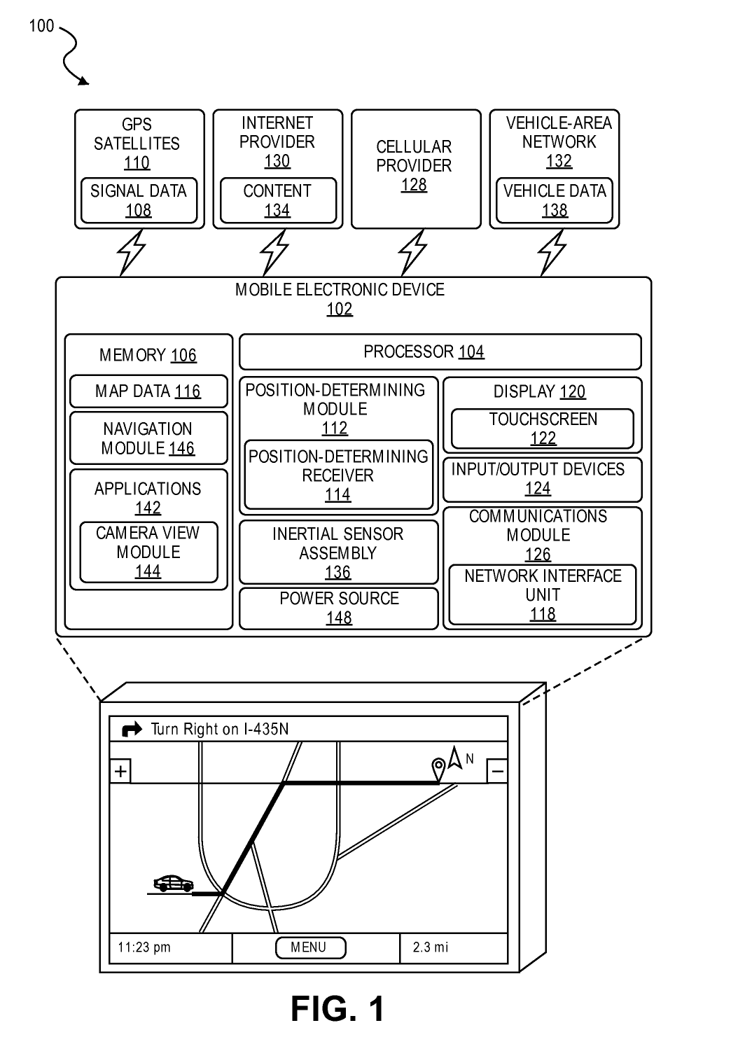

FIG. 1 illustrates an example mobile electronic device and environment 100 that is operable to perform the techniques discussed herein. The environment 100 includes a mobile electronic device 102, such as a navigation device, operable to provide navigation functionality to the user of the mobile electronic device 102. The mobile electronic device 102 may be configured in a variety of ways. For instance, a mobile electronic device 102 may be configured as a portable navigation device (PND), a mobile phone, a smart phone, a position-determining device, a hand-held portable computer, a personal digital assistant, a multimedia device, a game device, and any combinations thereof, that are capable of storing map data and presenting a portion of the map data corresponding to a determined geographic position of the mobile electronic device 102. In the following description, a referenced component, such as mobile electronic device 102, may refer to one or more entities, and therefore by convention reference may be made to a single entity (e.g., the mobile electronic device 102) or multiple entities (e.g., the mobile electronic devices 102, the plurality of mobile electronic devices 102, and so on) using the same reference number.

In FIG. 1, the mobile electronic device 102 is illustrated as including a processor 104 and a memory 106. The processor 104 provides processing functionality for the mobile electronic device 102 and may include any number of processors, micro-controllers, or other processing systems, and resident or external memory for storing data and other information accessed or generated by the mobile electronic device 102. The processor 104 may execute one or more software programs that implement the techniques and modules described herein. The processor 104 is not limited by the materials from which it is formed or the processing mechanisms employed therein and, as such, may be implemented via semiconductor(s) and/or transistors (e.g., electronic integrated circuits (ICs)), and so forth.

The memory 106 is an example of device-readable storage media that provides storage functionality to store various data associated with the operation of the mobile electronic device 102, such as the software program and code segments mentioned above, or other data to instruct the processor 104 and other elements of the mobile electronic device 102 to perform the techniques described herein. Although a single memory 106 is shown, a wide variety of types and combinations of memory may be employed. The memory 106 may be integrated with the processor 104, stand-alone memory, or a combination of both. The memory 106 may include, for example, removable and non-removable memory elements such as RAM, ROM, Flash (e.g., SD Card, mini-SD card, micro-SD Card), magnetic, optical, USB memory devices, and so forth. In embodiments of the mobile electronic device 102, the memory 106 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

The mobile electronic device 102 is further illustrated as including functionality to determine position. For example, mobile electronic device 102 may receive signal data 108 transmitted by one or more position data platforms and/or position data transmitters, examples of which are depicted as the Global Positioning System (GPS) satellites 110. More particularly, mobile electronic device 102 may include a position-determining module 112 that can manage and process signal data 108 received from GPS satellites 110 via a position-determining component, such as a GPS receiver, 114. The position-determining module 112 is representative of functionality operable to determine a geographic position through processing of the received signal data 108. The signal data 108 may include various data suitable for use in position determination, such as timing signals, ranging signals, ephemerides, almanacs, and so forth.

Position-determining module 112 may also be configured to provide a variety of other position-determining functionality. Position-determining functionality, for purposes of discussion herein, may relate to a variety of different navigation techniques and other techniques that may be supported by “knowing” one or more positions. For instance, position-determining functionality may be employed to provide position/location information, timing information, speed information, and a variety of other navigation-related data. Accordingly, the position-determining module 112 may be configured in a variety of ways to perform a wide variety of functions. For example, the position-determining module 112 may be configured for outdoor navigation, vehicle navigation, aerial navigation (e.g., for airplanes, helicopters), marine navigation, personal use (e.g., as a part of fitness-related equipment), and so forth. Accordingly, the position-determining module 112 may include a variety of devices to determine position using one or more of the techniques previously described.

The position-determining module 112, for instance, may use signal data 108 received via the position-determining component 114 in combination with map data 116 that is stored in the memory 106 to generate navigation instructions (e.g., turn-by-turn instructions to an input destination or POI), show a current position on a map, and so on. Position-determining module 112 may include one or more antennas to receive signal data 108 as well as to perform other communications, such as communication via one or more Internet providers 130, cellular provider 128, or vehicle-area network 132 described in more detail below. The position-determining module 112 may also provide other position-determining functionality, such as to determine an average speed, calculate an arrival time, and so on.

Although a GPS system is described above, it should be apparent that a wide variety of other positioning systems may also be employed, such as other global navigation satellite systems (GNSS), terrestrial based systems (e.g., wireless phone-based systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros, odometers, and magnetometers), use of “dead reckoning” techniques, and so on.

The mobile electronic device 102 includes a display device 120 to display information to a user of the mobile electronic device 102. In embodiments, the display device 120 may comprise an LCD (Liquid Crystal Display), a TFT (Thin Film Transistor) LCD display, an LEP (Light Emitting Polymer) or PLED (Polymer Light Emitting Diode) display, and so forth, configured to display text and/or graphical information such as a graphical user interface. The display device 120 may be backlit via a backlight such that it may be viewed in the dark or other low-light environments. The display device may display information in a portrait orientation, a landscape orientation, or rotate the information displayed depending on the orientation of mobile electronic device 102 itself.

The display device 120 may be provided with a screen 122 to present a user interface to enable user entry of data and commands. In one or more implementations, the screen 122 comprises a touch screen. For example, the touch screen may be a resistive touch screen, a surface acoustic wave touch screen, a capacitive touch screen, an infrared touch screen, optical imaging touch screens, dispersive signal touch screens, acoustic pulse recognition touch screens, combinations thereof, and the like. Capacitive touch screens may include surface capacitance touch screens, projected capacitance touch screens, mutual capacitance touch screens, and self-capacitance touch screens. In implementations, the screen 122 is configured with hardware to generate a signal to send to a processor and/or driver upon detection of a touch input and/or a hover input. Touch inputs include inputs, gestures, and movements where a user's finger, stylus, or similar object, contacts the screen 122. Hover inputs include inputs, gestures, and movements where a user's finger, stylus, or similar object, does not contact the screen 122, but is detected proximal to the screen 122.

The mobile electronic device 102 may further include one or more input/output (110) devices 124 (e.g., a keypad, buttons, a wireless input device, a thumbwheel input device, a trackstick input device, and so on). The 110 devices 124 may include one or more audio I/O devices, such as a microphone, speakers, and so on.

The mobile electronic device 102 may also include a communications module 126 representative of communication functionality to permit mobile electronic device 102 to send/receive data between different devices (e.g., components/peripherals) and/or over one or more networks, such as an Internet provider 130, cellular provider 128, and/or a vehicle-area network 132.

Communications module 126 may include or communicate with one or more Network Interface Units (NIU) 118. NIU 118 may be any form of a wireless transceiver known in the art, including but not limited to transceivers capable of communicating according to the following: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. However, it is to be understood that wired communications are also contemplated, such as through universal serial bus (USB), Ethernet, serial connections, and so forth. Mobile electronic device 102 may include multiple NIUs 118 (multiple wireless transceivers) for connecting to different networks, or a single NIU 118 (a single wireless transceiver) that can connect to each available wireless network.

The mobile electronic device 102, through functionality represented by the communications module 126, may be configured to wirelessly communicate with a cellular provider 128 and an Internet provider 130 to receive mobile phone service and various content 134, respectively. Content 134 may represent a variety of different content, examples of which include, but are not limited to: map data which may include speed limit data; web pages; services; music; photographs; video; email service; instant messaging; device drivers; instruction updates; and so forth.

Communications module 126 may also have a wired and/or wireless connection to a vehicle-area network (VAN) 132 for a vehicle within which it is used. Where such a vehicle-area network includes vehicle subsystem data 138 such as the engine control unit, cruise control, steering, and vehicle controls, it may also be referred to as a Controller Area Network (CAN). VAN 132 may include one or more integrated displays and/or speakers for the vehicle's entertainment system. When this is the case, mobile electronic device 102 may not include its own display but instead use the vehicle's integrated display. Alternatively, VAN 132 may not integrate into the vehicle itself, but rather connect peripherals and other devices installed in or used in the vehicle. VAN 132 may include a connection to Internet 130, so that device 102 communicates with Internet provider 130 via VAN 132 as opposed to directly.

The mobile electronic device 102 may further include an inertial sensor assembly 136 that represents functionality to determine various manual manipulation of the mobile electronic device 102. Inertial sensor assembly 136 may be configured in a variety of ways to provide signals to enable detection of different manual manipulation of the mobile electronic device 102, including detecting orientation, motion, speed, impact, and so forth. For example, inertial sensor assembly 136 may be representative of various components used alone or in combination, such as an accelerometer, gyroscope, velocimeter, capacitive or resistive touch sensor, and so on.

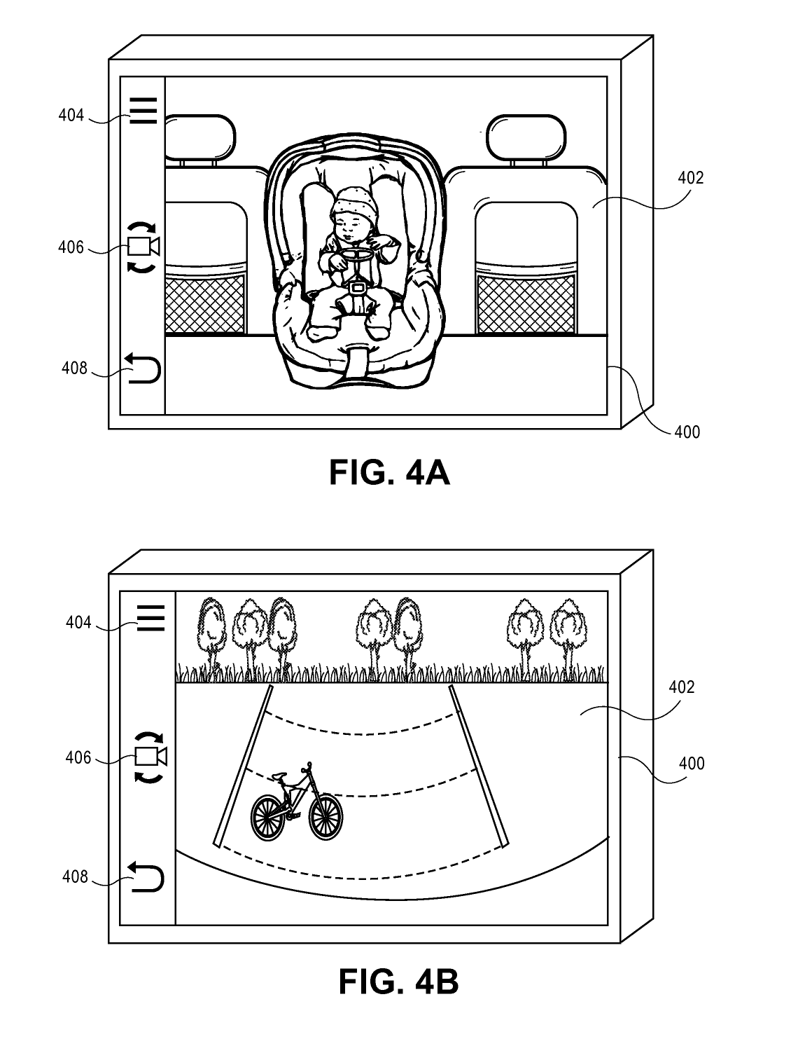

Applications 142 may comprise software, which is storable in memory 106 and executable by the processor 104, to perform a specific operation or group of operations to furnish functionality to the mobile electronic device 102. Example applications 142 may include cellular telephone applications, instant messaging applications, email applications, photograph sharing applications, calendar applications, address book applications, browser applications (to enable the mobile electronic device 102 to display and interact with content 134 such as a web page within the World Wide Web, a webpage provided by a web server in a private network, etc.), and so forth. As discussed in greater detail below with respect to FIGS. 4A and 4B, applications 142 can further include camera view module 144, which allows a user to display and switch between views from auxiliary camera units.

The mobile electronic device 102 is illustrated as including a navigation module 146, which is storable in memory 106 and executable by the processor 104. The navigation module 146 represents functionality to access map data 116 that is stored in the memory 106 to provide mapping and navigation functionality to the user of the mobile electronic device 102. For example, the navigation module 146 may generate navigation information that includes maps and/or map-related content for display by display device 120. As used herein, map-related content includes information associated with maps generated by the navigation module 146 and may include speed limit information, POIs, information associated with POIs, map legends, controls for manipulation of a map (e.g., scroll, pan, etc.), street views, aerial/satellite views, and the like, displayed on or as a supplement to one or more maps.

In one or more implementations, the navigation module 146 may be configured to utilize the map data 116 to generate navigation information that includes maps and/or map-related content for display by the mobile electronic device 102 independently of content sources external to the mobile electronic device 102. Thus, for example, the navigation module 146 may be capable of providing mapping and navigation functionality when access to external content 134 is not available through Internet provider 130. It is contemplated, however, that the navigation module 146 may also be capable of accessing a variety of content 134 via the Internet provider 130 to generate navigation information including maps and/or map-related content for display by the mobile electronic device 102 in one or more implementations.

The navigation module 146 may be configured in a variety of ways. For example, the navigation module 146 may be configured as an application 142. The navigation module 146 may utilize position data determined by the position-determining module 112 to show a current position of the vehicle (e.g., the mobile electronic device 102) on a displayed map, furnish navigation instructions (e.g., turn-by-turn instructions to an input destination or POI), calculate driving distances and times, access cargo load regulations, and so on.

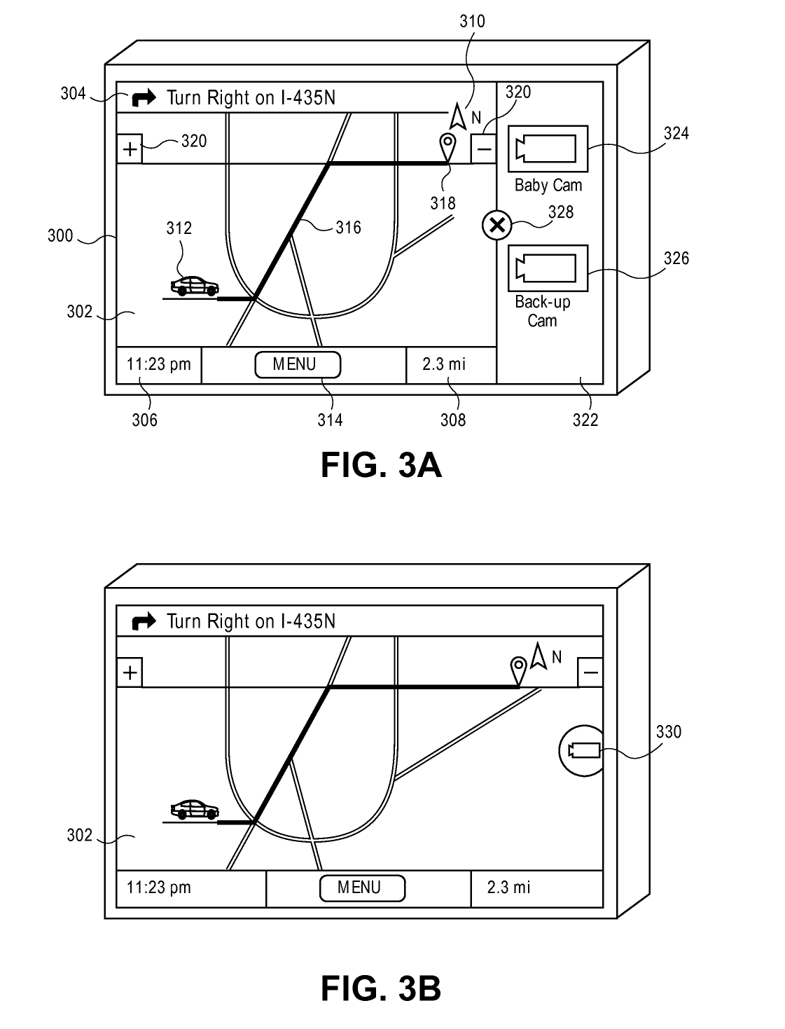

As shown in FIGS. 1 and 3B, the navigation module 146 may cause the display device 120 of the mobile electronic device 102 to be configured to display navigation information that includes a map, which may be a moving map, corresponding to the determined geographic position of the mobile electronic device 102 that includes a roadway graphic representing a roadway being traversed by a user of the mobile electronic device 102. The mobile electronic device 102 may be mounted or carried in a vehicle or other means of transportation in any location using a mount (e.g., windshield mount, dashboard mount, air vent mount, etc.) that enables stored map data and video data received by the NIU 118 (wireless transceiver) of communications module 126 to be presented on display 120.

The roadway represented by the roadway graphic may comprise, without limitation, any navigable path, trail, road, street, pike, highway, tollway, freeway, interstate highway, combinations thereof, or the like, that may be traversed by a user of the mobile electronic device 102. It is contemplated that a roadway may include two or more linked but otherwise distinguishable roadways traversed by a user of the mobile electronic device 102. For example, a roadway may include a first highway, a street intersecting the highway, and an off-ramp linking the highway to the street. Other examples are possible.

In embodiments, mobile electronic device 102 includes a power source 148 that provides electrical power to the mobile electronic device independent of the vehicle. For instance, the power source 148 may be a battery that is not electrically coupled with a vehicle battery and/or solar panels. In other embodiments, power source 148 is a cable extending from the mobile electronic device 102 that may be electrically coupled with a vehicular power source providing AC or DC power and, if necessary, transform it appropriately for use by mobile electronic device 102.

As a non-limiting example, power source 148 in such embodiments is a cable extending from the mobile electronic device 102 and electrically coupled the vehicular power source to provide electrical power to other elements of mobile electronic device 102. For example, power source 148 may plug into a 12V DC outlet of a vehicle and transform the voltage of the received electrical signal so as to provide 5V DC to device 102. In some such embodiments, power received using a power source 148 in the form of a cable is independent of environment 100. In other embodiments, it is affected by environment 100. For example, when mobile electronic device 102 is mounted within a vehicle, power source 148 may provide electrical power only when the vehicle is running or otherwise powered on. In some embodiments, NIU 118 (a wireless transceiver as discussed above) may be integrated into power source 148 in the form of a cable extending from the mobile electronic device 102. In such embodiments, NIU 118 may be operable to wirelessly transmit and/or receive data only when the vehicle is powered on, or only for a brief period after the vehicle is powered off, or transition the power source 148 such that it does not require an external power source by now relying on an internal an source of power.

Generally, any of the functions described herein may be implemented using software, firmware, hardware (e.g., fixed logic circuitry), manual processing, or a combination of these implementations. The terms “module” and “functionality” as used herein generally represent software, firmware, hardware, or a combination thereof. The communication between modules in the mobile electronic device 102 of FIG. 1 may be wired, wireless, or some combination thereof. In the case of a software implementation, for instance, the module represents executable instructions that perform specified tasks when executed on a processor, such as the processor 104 with the mobile electronic device 102 of FIG. 1. The program code may be stored in one or more device-readable storage media, an example of which is the memory 106 associated with the mobile electronic device 102 of FIG. 1.

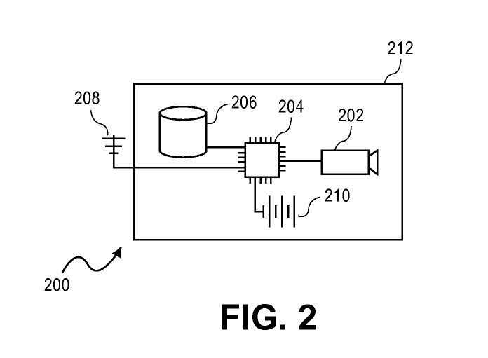

FIG. 2 presents a system level diagram of an exemplary auxiliary camera unit. The auxiliary camera unit of FIG. 2 is generally referred to by reference numeral 200. In some embodiments, auxiliary camera unit 200 may be a standalone unit suitable for aftermarket installation in a vehicle by the consumer. For example, auxiliary camera unit 200 may be mounted (e.g., to a headrest post) and used as an in-cabin camera oriented to view the front and/or back seat. For instance, the auxiliary camera unit 200 may be oriented to view a baby seated in the back seat of a vehicle. Similarly, the auxiliary camera unit 200 may be oriented to view the entire backseat of a vehicle to enable the user to view multiple passengers or pets in the backseat. In other embodiments, the auxiliary camera unit 200 may be mounted (e.g., to a portion of a rear license-plate frame) and used as a back-up camera oriented to capture a view of the area immediately behind the vehicle to assist the driver when the vehicle is reversed. In still other embodiments, auxiliary camera unit 200 may be mounted (e.g., to the vehicle windshield or dash) and used as a dash camera usable to record a trip from the driver's perspective. One auxiliary camera unit 200 or a plurality of auxiliary camera units 200 (each representing a different view) may be used in implementations.

In embodiments, an auxiliary camera unit 200 must be wirelessly paired with mobile electronic device 102 to enable camera display system be configured to display video on the display 120 of mobile electronic device 102 from a particular auxiliary camera unit 200. Generally, each auxiliary camera unit 200 is said to be “paired” with mobile electronic device 102. The mobile electronic device 102 remains paired with the auxiliary camera unit 200 even when the auxiliary camera unit 200 is in a low-power state and the mobile electronic device 102 may be simultaneously paired with multiple auxiliary camera units 200.

Auxiliary camera unit 200 includes video camera 202 operable to capture video data. Video camera 202 may be any component capable of digitally capturing imagery in front of the auxiliary camera unit 200. Typically, the auxiliary camera unit 200 is oriented to capture video data of an area of interest to a user of the system and may vary depending on the use to which auxiliary camera unit 200 is adapted. For example, video camera 202 may employ a wide-angle fish-eye lens to maximize the field of view when used in a back-up camera role. In some embodiments, the field of view, focus, or other camera settings may be adjustable either electronically or manually. In some embodiments, video camera 202 may further include low-light or infrared capability, so as to capture imagery at night. In some embodiments, video camera 202 may emit, using a light source, and capture light in the visible and infrared spectrum in order to illuminate the field of view when ambient light is insufficient. In some embodiments, video camera 202 may include remotely adjustable pan/tilt/zoom functionality so as to allow a user to adjust the field of view without the need to manually adjust the video camera 202. In some embodiments, the video camera 202 additionally includes functionality for a user to mirror-flip or rotate captured video data based on the orientation of the auxiliary camera unit 200 or the mobile electronic device 102. In other embodiments, the functionality of adjusting the camera settings is automatically carried out by processor 204 or by device 102.

Auxiliary camera unit 200 also includes processor 204 for controlling the operation of video camera 202 and the other components of auxiliary camera unit 200. In some embodiments, processor 204 may be a low-power system-on-chip design. In some embodiments, a single printed circuit board serves to mount the processor 204 and the other internal components of auxiliary camera unit 200. In some embodiments, auxiliary camera unit 200 also includes a memory 206. Memory 206 may comprise volatile memory, non-volatile memory, or a combination of both. For example, where auxiliary camera unit 200 is used as a dash camera, memory 206 may automatically store the last 60 seconds (or other amount) of video data captured by video camera 202. A user interface presented on the display 120 of mobile electronic device 102 may enable the video data stored in memory 20 to be permanently retained in response to a user input, such as in the event of an accident. In other embodiments, video data captured by video camera 202 may be retained only as long as it takes to be processed and transmitted to mobile electronic device 102.

Auxiliary camera unit 200 further includes a network interface unit (NIU) 208. Similar to NIU 118 of mobile electronic device 102, NIU 208 may be any wireless transceiver operable to use a wireless communication protocol such as Bluetooth or Wi-Fi. In other embodiments, alternative networking protocols are used. In some embodiments, such as the system-on-chip embodiment discussed above, NIU 208 and memory 206 may be integrated within processor 204.

In some embodiments, NIU 208 (wireless transceiver) incorporates wake-on-LAN functionality. In such embodiments, auxiliary camera unit 200 may be kept in a powered-down state until NIU 208 receives network traffic, whereupon it may automatically be powered on to operate in a predetermined manner. For example, auxiliary camera unit 200 may enter and remain in a powered-off state until a user input is received on a user interface presented on the display 106 of mobile electronic device 102, or an audible voice command is sensed by a microphone integrated within auxiliary camera unit 200, causing the auxiliary camera unit 200 to capture video data using the video camera 202 and store the video data in memory 206. In embodiments, processor 204 may cause the NIU 208 (wireless transceiver) to power on and wirelessly communicate the video data stored in memory 206 for a predetermined video display duration. By keeping the auxiliary camera unit 200 powered-off when the user is not interested in viewing video content from the auxiliary camera unit 200, the amount of energy drawn from power source 210 is reduced significantly.

In other embodiments, auxiliary camera unit 200 may wake up periodically to poll for activation signals transmitted by NIU 118 (wireless transceiver) of mobile electronic device 102. For example, processor 204 and NIU 208 (wireless transceiver) of auxiliary camera unit 200 may periodically power-up for a predetermined length of time, such as 100 ms every second, to determine if an activation signal has been transmitted by NIC 118 of mobile electronic device 102.

In some embodiments, a third, ultra-low-power level (separate from the powered-on and polling states) may be utilized to determine whether auxiliary camera unit 200 should enter the polling state to poll for an activation signal. For example, auxiliary camera unit 200 may include an accelerometer that may be used to determine whether a vehicle, within or on which the auxiliary camera unit 200 is mounted, is presently moving or has ceased movement for an extended period of time (e.g., 10 minutes). Long periods without movement may indicate that the vehicle is parked and that polling should be suspended until movement is detected by the accelerometer again.

Power source 210 may be any of the forms of power source discussed above with respect to device 102. In some embodiments, power source 210 may comprise one or more batteries having at least one electrochemical cell. Because the techniques disclosed herein may enable the auxiliary camera unit 200 to require less electrical power to operate, it may be practical for the auxiliary camera unit 200 to be used without use of an external power source for an extended period of time. In other embodiments, power source 210 is a cable extending from auxiliary camera unit 200 that is electrically coupled to a vehicle's 12V outlet, as discussed above with respect to power source 148. In still other embodiments, power source 210 is rechargeable batteries that may temporarily couple with a vehicular power source for recharging. In some embodiments, processor 204 is operable to determine whether auxiliary camera unit 200 is using battery power or an external power source and communicating this information to mobile electronics device 102. Processor 104 of the mobile electronics device 102 may cause battery level information to be presented on display 106.

The components of auxiliary camera unit 200 are housed wholly or partially within housing 212. Housing 212 is adapted to secure auxiliary camera unit 200 such that video camera 202 is oriented appropriately for the use of interest. For example, where auxiliary camera unit 200 is mounted and used as a baby camera, housing 212 may include radiused edges with rounded corners and a mount for attaching auxiliary camera to a headrest post of a front-row seat. As another example, if auxiliary camera unit 200 is mounted and used as a back-up camera, housing 212 may be waterproof and be mounted to or integral to a license plate holder. Alternatively, housing 212 could include one or more mounting holes allowing it to be securely attached to an existing license plate holder. In other embodiments, housing 212 may include suction cups for attachment to a vehicle window. Other mounting options for auxiliary camera unit 200 are also contemplated.

Example Displays

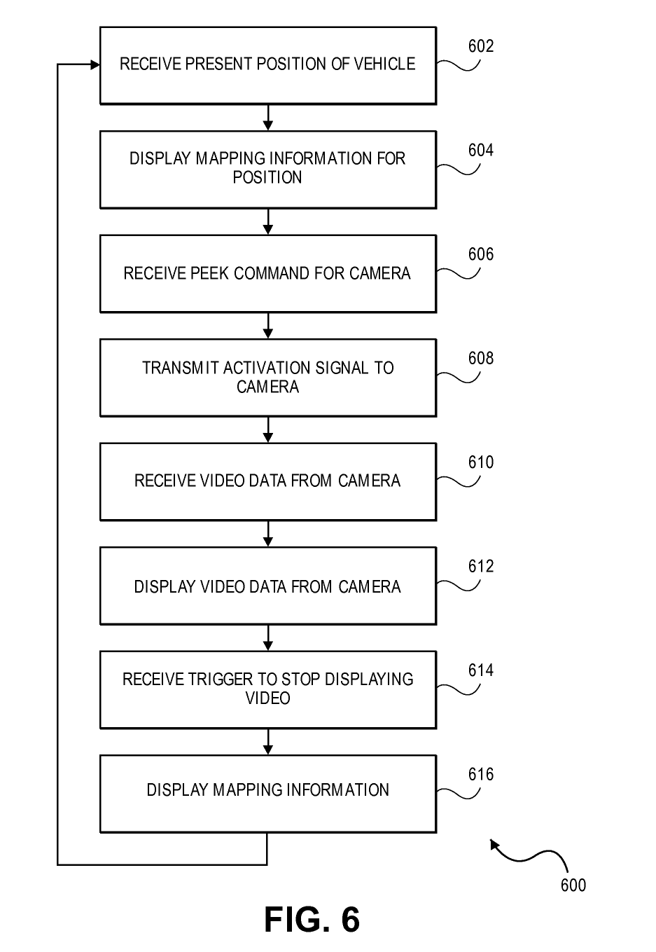

The following discussion describes example display screens that may be generated using the processes and techniques discussed herein. Aspects of the display screens may be generated in hardware, firmware, software, or a combination thereof. In portions of the following discussion, reference will be made to the environment 100 of FIG. 1, the procedures 600 of FIG. 6, and/or other example environments and procedures. The navigation device 102 incorporates the above-described functionality of mobile electronic device 102.

FIG. 3A presents a mapping interface suitable for display on the navigation device 102, which is referred to generally by reference numeral 300. Mapping interface 300 includes navigation view 302, which provides local map information and/or navigation instructions for the driver. As illustrated, navigation view 302 depicts an overhead map view of the roads being traversed. Other views, such as a three-dimensional view approximating the roads ahead from a driver's point-of-view, may also be present and, in some embodiments, may be switched between by a user of the navigation device. Mapping interface 300 may contain the functionality usable for navigation. For example, as illustrated in FIG. 3A, in addition to the map itself, navigation view 302 includes next-turn information 304 (for example, as a part of turn-by-turn navigation information), estimated time of arrival 306, estimated distance to the destination 308, and compass 310. When navigation view 302 includes an overhead map view, a current position 312 for the vehicle may also be displayed. In some embodiments, a selector 314 may be provided for allowing a user to specify a destination for navigation instructions, as is known in the art. When a destination is provided, a route overlay 316 may be displayed on navigation view 302 as well. In some embodiments, an icon 318 representing the selected destination may also be displayed when the map has been scaled (either automatically or using zoom buttons 320) to include the selected destination.

Mapping interface 300 may further include a camera-view pane 322, which allows quick access to all of the auxiliary camera units 200 with which navigation device 102 is paired. As depicted, camera-view pane 322 depicts an icon 324 corresponding to a paired baby camera and an icon 326 corresponding to a paired back-up camera. In some embodiments, thumbnail representations of the available camera views may be displayed instead of icons. More or fewer icons may be displayed depending on the number of auxiliary camera units 200 paired and the user's preferences. In some embodiments, camera-view pane 322 may be scrolled to access additional camera icons. As described in greater detail below, receiving a user selection of one of the camera icons such as camera icon 324 may cause a peek command to be generated, which in turn changes the display from mapping interface 300 to camera-view interface 400, so that video from the selected auxiliary camera unit 200 is displayed. Camera-view pane 322 may further include close icon 328. If the user selects close icon 328, camera-view pane is 322 collapsed, as depicted in FIG. 3B and discussed below.

FIG. 3B shows an alternate mode of the mapping interface of FIG. 3A. In some embodiments, the mode of FIG. 3A is initially displayed, and the view of FIG. 3B is only displayed when the user selects close icon 328. The user may do this, for example, to increase the screen area available to show navigation view 302. In the depicted alternate view of FIG. 3B, all of the components of navigation view 302 remain visible, and the space formerly occupied by camera-view pane 322 is available to display additional portions of the map or other information. In this alternate view, mapping interface 300 includes camera display icon 330 instead of camera-view pane 322. In some embodiments, camera display icon 330 causes the alternate view of FIG. 3B to return to the view of FIG. 3A by returning camera-view pane 322 to mapping interface 300. In other embodiments, camera display icon 330 instead changes the display to the camera-view interface 400 corresponding to a preconfigured default camera, as discussed below. In still other embodiments, camera display icon 330 displays camera-view pane 322 if multiple auxiliary camera units 200 are paired with navigation device 102, and camera-view interface 400 if only a single auxiliary camera unit 200 is paired with navigation device 102.

FIG. 4A depicts a first camera-view interface also suitable for display on navigation device 102. The interface of FIG. 4 is referred to generally by reference numeral 400. FIG. 4A depicts a view field 402 of an auxiliary camera unit 200 corresponding to a rear-seat baby camera. As described above, such a camera may be mounted to a post of a front (for front-facing car seats) or rear (for rear-facing car seats) seat headrest. In addition to view field 402, camera-view interface 400 may also include controls for changing its operation. For example, camera-view interface 400 may include menu icon 404 for changing the current camera settings (for example, by changing the field of view of the corresponding camera, changing a view mode from a daytime view to a nighttime view, causing camera imagery to be rotated or reflected, and so forth). In some embodiments, the menu further shows a battery level for the auxiliary camera. In other embodiments, the camera battery level is shown in camera-view interface 400. In such embodiments, camera battery levels can be queried on demand from the corresponding auxiliary camera unit or continuously updated by periodically polling the auxiliary camera units with battery level request messages. In some embodiments, a plug icon (or other similar indication of an external power source) can replace the battery power level display when device 102 determines (as discussed above) that the corresponding auxiliary camera unit is using an external power source. In some embodiments, menu icon 404 may also allow a user to pair the navigation device 102 with additional auxiliary camera units 200.

When device 102 is paired with multiple cameras, switch camera icon 406 may be present to allow the user to rotate among the available camera views. In some embodiments, switch camera icon 406 instead displays a pane similar to camera-view pane 322 to allow the user to select a camera to view. In other embodiments, switch camera icon 406 instead simply iterates through the cameras in the list of paired cameras. In some embodiments, camera-view interface 400 may also include back icon 408 for returning to mapping interface 300. In other embodiments, memory 106 of navigation device 102 may include a video display duration (e.g., 10 seconds, 20 seconds, 30 seconds, etc.) that may be set by a user as the duration of video content to be presented on display 120 from a selected auxiliary camera unit 200. In embodiments, processor 104 includes the stored video display duration in the communication from NIU 118 to a selected auxiliary camera unit 200 when video content from the selected auxiliary camera unit 200 is to be communicated to navigation device 102, such as in response to a user input indicating that video content is desired. In embodiments, navigation interface 400 returns to mapping interface 300 automatically after the video display duration has completed. This video display duration may be user-configurable. In still other embodiments, navigation interface 400 may return to mapping interface 300 automatically after the predetermined period or when the user selects back button 408, whichever comes first.

FIG. 4B shows a second camera-view interface also suitable for display on navigation device 102 and also corresponding to reference numeral 400. FIG. 4B depicts a view field 402 such as might be provided by a back-up camera. As depicted, view field 402 of FIG. 4B depicts a trajectory for the vehicle together with ranging indications. The camera-view interface 400 of FIG. 4B includes the same controls as the camera-view interface 400 of FIG. 4A and operates generally similarly. In some embodiments, however, a user may designate the function of an auxiliary camera unit 200 when it is paired. This may allow for different functionality or configurations to be applied to different auxiliary camera units 200. For example, the view from a back-up camera may automatically be displayed when the vehicle is put into reverse gear, while the view from a baby camera may automatically be displayed when the vehicle is switched off. Similarly, while the view from a baby camera may automatically revert to a mapping interface after a predetermined period, the view from a back-up camera may not revert until the vehicle is placed in a forward gear, and the view from a dash camera may not revert at all until the user selects back button 408.

Although FIGS. 3A, 3B, 4A and 4B depict the presentation of either mapping interface 300 (map data and navigational content) or camera-view interface 400 (video data received by the navigation device 102 from a selected auxiliary camera unit 200), it is to be understood that the mapping interface 300 and the camera-view interface 400 may be presented on display 106 simultaneously. For instance, in some implementations, processor 104 of navigation device 102 may present mapping interface 300 and the camera-view interface 400 in a split-screen mode layout (e.g., side-by-side, top-and-bottom, etc.). Thus, in embodiments, video data received by communications module 126, including a NIU 118 (a wireless transceiver), and map data corresponding to a position of the navigation device determined by a position-determining module 112 may be displayed simultaneously on a display of the navigation device 102. In other embodiments, mapping interface 300 and camera-view interface 400 can be simultaneously displayed using a picture-in-picture arrangement of the display. Other arrangements for the simultaneous display of mapping interface 300 and camera-view interface 400 are also contemplated as being within the scope of this disclosure.

In some embodiments, processor 104 may enable a user to interact with the touchscreen 122 to make adjustments to the portion of the display that is presenting mapping interface 300 (map data and navigational content) and camera-view interface 400 (video data received by the navigation device 102 from a selected auxiliary camera unit 200). For instance, a user interface presented on display 106 may include one or more lines separating panes for the mapping interface 300 and the camera-view interface 400 on a combined interface. Processor 104 may identify user inputs to the line as a dragging motion to move the one or more lines and resize the mapping interface 300 and camera-view interface 400 accordingly. For instance, if the mapping interface 300 and the camera-view interface 400 used equal portions of available display area on display 106, inputs expanding the mapping interface 300 cause the camera-view interface 400 to contract and inputs expanding the camera-view interface 400 cause the mapping interface to contract. Alternatively, if the mapping interface 300 and the camera-view interface 400 used different portions of available display area on display 106, inputs to touchscreen 122 may cause mapping interface 300 and the camera-view interface 400 to use equal portions of available display area (each uses half of the available display area).

In embodiments, processor 104 may associate the display area corresponding to camera-view interface 400 as the view icon described elsewhere herein. As a result, processor 104 may identify a user input to the display area corresponding to camera-view interface 400 via touchscreen 122 and cause communications module 126, including a NIU 118 (wireless transceiver), to transmit an activation signal including a video display duration to an auxiliary camera unit 200 associated with the camera-view interface 400.

As described above, in embodiments, navigation device 102 is configured to communicate with a plurality of auxiliary camera units 200. In such embodiments, processor 104 may simultaneously present a first camera-view interface 400 and a second camera-view interface 400 on display 106.

Example Deployment

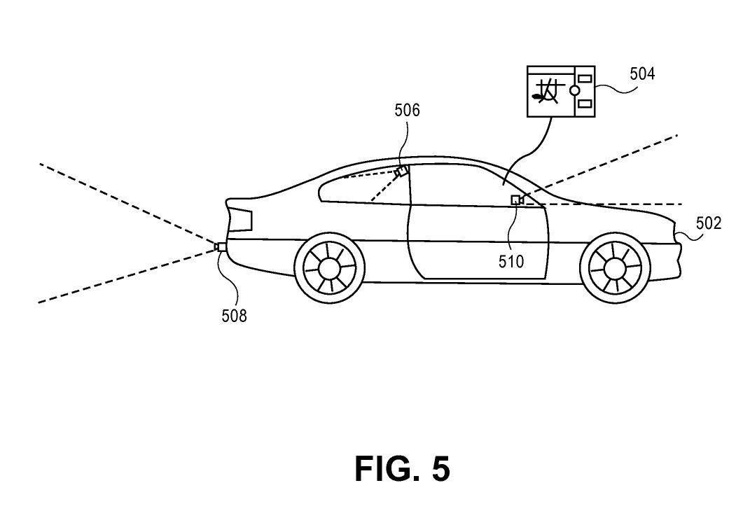

FIG. 5 illustrates an exemplary deployment scenario for an implementation. In this scenario, the driver of vehicle 502 has a portable, dash-mounted navigation device 504 (such as navigation device 102) installed in vehicle 502. As discussed above, implementations may employ one auxiliary camera unit 200 or a plurality of auxiliary camera units. In embodiments with multiple auxiliary camera units, each auxiliary camera unit such as auxiliary camera unit 506, auxiliary camera unit 508, and auxiliary camera unit 510 may store a device identifier in a memory of each auxiliary camera unit. When the driver of vehicle 502 activates a particular auxiliary camera unit using navigation device 504, the activation signal can include a target device identifier. In such embodiments, when an auxiliary camera unit receives an activation signal, it does not activate unless the target device identifier matches the stored device identifier.

In the depicted deployment, three auxiliary camera units are depicted. The first camera unit depicted is baby camera 506. As discussed above, a baby camera may be mounted from a post of a headrest of a front or rear seat and oriented so as to capture a view of a child seat. In some embodiments, baby camera 506 is activated by a peek command automatically generated by processor 104 when the engine of vehicle 502 is determined to be turned off. This may be accompanied by a textual reminder for the user to check for passengers remaining in the rear seats, either on the display, via an audible alert, or both. In some embodiments, this reminder is only presented when it can be determined (for example, using image-recognition or motion-detection algorithms, as known in the art) that there are passengers in the rear seat. In some embodiments, data is transmitted and displayed in real-time from the appropriate auxiliary camera unit. In other embodiments, as discussed above, the NIU 118 (a wireless transceiver) of dash-mounted navigation device 504 (such as navigation device 102) is integrated into a power source that extends from the navigation device 504. Accordingly, the transceiver may not be operable to send or receive data when the vehicle is turned off, or may only be able to do so for a brief time after the vehicle is turned off, without transitioning to an internal power source that is not dependent on an external power source. In such embodiments, the device 102 may store a last received frame of video to be displayed when vehicle 502 is determined to be powered off by processor 104. In other embodiments, baby camera 506 is activated by noise detection, such as the noise of a baby crying. Other sources of signals activating baby camera 506 are also contemplated. For instance, as described above, baby camera 506 may include a microphone operable to detect a voice command to activate the baby camera 506. When activated, baby camera 506 may be manually deactivated or be automatically deactivated after a video display duration. In some embodiments, baby camera may be automatically deactivated if baby camera 506 is using battery power but remain active until manually deactivated if it is using an external power source.

The second auxiliary camera unit is back-up camera 508. As illustrated, back-up camera 508 is mounted and oriented so as to capture a view of the area immediately behind the vehicle and may be automatically activated when a peek command is received in response to user input, the vehicle being shifted into reverse gear, or when it is detected that the vehicle is moving backwards. Such a view may be automatically deactivated once the vehicle is shifted into a forward drive gear or starts to move forward. Alternatively, if the back-up camera 508 is activated manually, the view may continue until the user manually deactivates it.

The last of the depicted auxiliary camera units is dash camera 510. In some deployments, dash cameras such as dash camera 510 continually maintain a recording of a previous interval of time (e.g., the last 30 seconds or one minute). Such cameras may remain active for the purposes of capturing and storing video at all times but only transmit video data to navigation device 504 when specifically requested to do so (for example, for the purpose of aiming the dash camera 510). Such dash cameras 510 may not be automatically activated or deactivated at all but rather rely on manual activation. Of course, one of skill in the art will appreciate that other types of auxiliary camera units are also usable, as are multiple instances of the same type of auxiliary camera unit 200. For example, a large vehicle such as a minivan may include multiple baby-cameras 506. Similarly, auxiliary camera units 200 can be positioned to capture other viewing areas, such as the blind spots of a vehicle. All such types and deployments of auxiliary camera units are contemplated as being within the scope of the disclosed embodiments.

Example Procedures

The following discussion describes procedures that can be implemented in a mobile electronic device providing navigation functionality. The procedures can be implemented as operational flows in hardware, firmware, software, or a combination thereof. These operational flows are shown below as a set of blocks that specify operations performed by one or more devices and are not necessarily limited to the orders shown for performing the operations by the respective blocks. In portions of the following discussion, reference can be made to the environment 100 of FIG. 1 and the environment 200 of FIG. 2. The features of the operational flows described below are platform-independent, meaning that the operations can be implemented on a variety of commercial mobile electronic device platforms having a variety of processors.

FIG. 6 presents a flowchart illustrating the operation of a method of selectively activating auxiliary camera units. The method of FIG. 6 is referred to generally by reference numeral 600. Method 600 begins at a step 602, where position information for the navigation device (and, by proxy, for the vehicle) is received. As discussed above, position information may be received via a GPS receiver, by vehicle-supplied information for dead reckoning, by triangulating from beacons of known position, or from any other source. Once the position information for the vehicle has been received, processing proceeds to step 604.

At step 604, mapping information corresponding to the position of the vehicle is displayed. In some embodiments, it is displayed on a screen of a navigation device. In other embodiments, it may be displayed on a dash-mounted screen. In some embodiments, the mapping data may be retrieved from a local memory. In other embodiments, the mapping data may be retrieved via an Internet connection. In some embodiments, the mapping data depicts the area (e.g., the road network) around the vehicle. In other embodiments, it includes turn-by-turn navigation information calculated based on the position of the vehicle and a specified destination.

Next, at step 606, a peek command is received for a camera of an auxiliary camera unit. This peek command may be generated by a user selecting a view icon corresponding to the desired camera or by a triggering event such as the car being placed in reverse or park. In some embodiments, peek commands can be received via any of the input devices 124 of device 102. For example, the user may provide a voice command to generate a peek command and thereby activate a camera. In some embodiment, these triggering events are received via a vehicle-area network. In other embodiments, they are inferred based on vehicle position data. In still other embodiments, the peek command is generated by the device itself based on, for example, a determination that it is no longer receiving power from the vehicle (and therefore an inference that the vehicle has been turned off).

At step 608, in response to receiving the peek command, an activation signal is generated for the corresponding camera and transmitted to the camera. As discussed above, implementations may include multiple camera units. In such embodiments, the activation signal may be addressed individually to the selected camera by a target device identifier. This signal may be sent via a wired connection to a camera unit if such a wired connection is available or it may be sent wirelessly (for example, via Bluetooth connection to the camera). The signal, once received by the auxiliary camera unit, causes the auxiliary camera unit to transition from an inactive state to an active state and begin transmitting video data. In some embodiments, the activation signal may include video settings, such as a desired zoom level, image orientation or reflection, and/or the above-discussed video display duration.

In some embodiments, the activation signal includes a desired operating state for the camera. For example, camera may be instructed to begin transmitting data, stop transmitting data, enter an active state, enter a low-power inactive state, or enter an ultra-low-power hibernation state. In some embodiments, the activation signal may include a request for the current power level of the auxiliary camera unit. In some embodiments the activation signal may further include a request for the auxiliary camera unit to report its battery level and then return to a low-power state.

Video data from the auxiliary camera unit is received at step 610. The video data may be in any format or encoding now known or later developed, and may be at any resolution and frame rate suitable for display on device 102. Like the activation signal, the video data may be transmitted via a wired connection or a wireless connection. Once the relevant camera unit has received the activation signal and begun transmitting video data, the video data may be displayed at step 612. In some embodiments, only the video data from a single auxiliary camera unit may be displayed. In other embodiments, the video data from multiple related auxiliary camera units (for example, from all baby cameras) or from all cameras may be displayed simultaneously. Video data from the camera continues to be displayed until an event triggers an end.

At step 614 the event triggering the end of video data being displayed is received. As discussed above, these triggers may include the elapse of a predetermined period of time since the activation signal was transmitted, the user manually selecting an icon to close the camera view, the end of an event that triggered the video to be displayed, or some other event. In some embodiments, as well as terminating the display of video data, the trigger signal further causes a deactivation signal to be sent to the one or more camera units that were activated, causing them to transition to the inactive (low-power sleep) state. In embodiments, the one or more camera units may deactivate based on a time-out functionality (e.g., 30 seconds). Finally, at a step 616, mapping data is once again displayed. At this point, processing returns to step 602 where, as updated position information is received for the vehicle, updated mapping information is displayed until the next peek command is received and the method continues. In some embodiments, rather than a separate deactivation signal, the activation signal includes a video display duration. When an auxiliary camera unit receives such a signal, it enters an active state and begins transmitting data for the video display duration (e.g., 10, 20, or 30 seconds or as otherwise configured by the user) and then automatically reverts to a low-power sleep state without the need for a separate deactivation signal.

As has been discussed above, each of the auxiliary camera units is generally kept in an inactive (low-power, sleep) state unless there is a reason for it to be capturing and transmitting video data for display. Because the video data from each camera is needed only a small fraction of the time, this results in a dramatic savings in the amount of energy consumed over time. It is this reduced energy draw that enables the use of small, battery-powered, easy-to-install auxiliary camera units for capturing video data in circumstances where it was previously infeasible.

### CONCLUSION

Although the foregoing text sets forth a detailed description of numerous embodiments of systems and methods for selectively displaying video data on the screen of a navigation device in terms of specific structural features and acts, it is to be understood that the appended claims are not to be limited to the specific features and acts described. Rather, the specific features and acts are disclosed as exemplary forms of implementing the claimed devices and techniques. In light of the foregoing text, numerous alternative embodiments may be implemented, using either current technology or technology developed after the filing date of this patent application.

Having thus described various embodiments of the technology, what is claimed as new and desired to be protected by the Letters Patent includes the following:

1. A camera display system, comprising:
a navigation device, comprising:
a memory operable to store map data, video data and a video display duration;
a position-determining component operable to determine a geographic position of the navigation device;
a first wireless transceiver;
a display having a touch screen, the display operable to display a portion of the map data corresponding to the determined geographic position of the navigation device; and
a first processor coupled to the memory, the position-determining component, the first wireless transceiver, and the display, the first processor operable to:
cause the wireless transceiver to transmit an activation signal including the video display duration, and
present video data received by the wireless transceiver on the display; and
an auxiliary camera unit, comprising:
a video camera operable to capture video data;
a second wireless transceiver operable to communicate with the first wireless transceiver; and
a second processor coupled to the video camera and the second wireless transceiver, the second processor operable to transition to an active state and cause the second wireless transceiver to begin transmitting video data captured by the video camera to the navigation device for the video display duration when the second wireless transceiver is determined to receive the activation signal from the first wireless transceiver.

2. The camera display system of claim 1, wherein the first processor is further operable to determine whether the auxiliary camera unit is using battery power or an external power source.

3. The camera display system of claim 1, wherein the activation signal further includes a target device identifier associated with the auxiliary camera unit.

4. The camera display system of claim 3, wherein the auxiliary camera unit further comprises a memory storing a device identifier, and the second processor is further operable to transition to the active state when the target device identifier matches the stored device identifier.

5. The camera display system of claim 1, wherein the navigation device is coupled to an external power source and the first processor causes stored video data to be automatically displayed on the display when the navigation device is determined to lose power from the external power source.

6. The camera display system of claim 1, wherein the first processor is further operable to cause video data received by the wireless transceiver and the map data corresponding to the determined position of the navigation device to be displayed simultaneously on the display.

7. The camera display system of claim 1, wherein the video data is transmitted in real-time.

8. The camera display system of claim 1, wherein the activation signal further includes an operating state for the auxiliary camera unit, a current power level request, and video settings.

9. The camera display system of claim 1, wherein the activation signal is sent as a result of a selection, by a user, of a view icon presented on the display.

10. The camera display system of claim 9, wherein the view icon is presented in conjunction with the map data on the display.

11. A camera display system, comprising:
a navigation device, comprising:
a memory operable to store map data and video data;
a position-determining component operable to determine a geographic position of the navigation device;
a first wireless transceiver;
a display having a touch screen, the display operable to display a portion of the map data corresponding to the determined position of the navigation device; and
a first processor coupled to the memory, the position-determining component, the first wireless transceiver, and the display, the first processor operable to:
cause the wireless transceiver to transmit an activation signal including a target device identifier, and
present video data received by the wireless transceiver on the display; and
an auxiliary camera unit, comprising:
a video camera operable to capture video data;
a memory storing a device identifier;
a second wireless transceiver operable to communicate with the first wireless transceiver; and
a second processor coupled to the video camera and the second wireless transceiver, the second processor operable to transition to an active state and cause the second wireless transceiver to begin transmitting video data captured by the video camera to the navigation device when the second wireless transceiver is determined to receive the activation signal from the first wireless transceiver and the target device identifier matches the stored device identifier.

12. The camera display system of claim 11, wherein the first processor is further operable to determine whether the auxiliary camera unit is using battery power or an external power source.

13. The camera display system of claim 11, wherein the activation signal further includes a video display duration, and wherein the auxiliary camera unit transmits video data for the video display duration when the second wireless transceiver is determined to receive the activation signal from the first wireless transceiver and the target device identifier matches the stored device identifier.

14. The camera display system of claim 11, wherein the navigation device is coupled to an external power source and the first processor causes stored video data to be automatically displayed on the display when the navigation device is determined to lose power from the external power source.

15. The camera display system of claim 11, wherein the first wireless transceiver is integrated into the external power source.

16. The camera display system of claim 11, wherein the first processor is further operable to cause video data received by the wireless transceiver and the map data corresponding to the determined position of the navigation device to be displayed simultaneously on the display.

17. The camera display system of claim 11, wherein the video data is transmitted in real-time.

18. The camera display system of claim 11, wherein the activation signal further includes an operating state for the auxiliary camera unit, a current power level request, and video settings.

19. The camera display system of claim 11, wherein the activation signal is sent as a result of a selection, by a user, of a view icon presented on the display.

20. The camera display system of claim 19, wherein the view icon is presented in conjunction with turn-by-turn navigation instructions on the display.
